(19) United States
(12) Patent Application Publication
(10) Pub. No.: US 2023/0318128 A1
(43) Pub. Date: Oct. 5, 2023

(54) BATTERY MODULE AND BATTERY PACK INCLUDING THE SAME

(71) Applicant: LG ENERGY SOLUTION, LTD., Seoul (KR)

(72) Inventors: Kwangmo KIM, Daejeon (KR); Junyeob SEONG, Daejeon (KR); Hyemi JUNG, Daejeon (KR); Dayoung BYOUN, Daejeon (KR)

(21) Appl. No.: 18/022,702

(22) PCT Filed: Jan. 11, 2022
(86) PCT No.: PCT/KR2022/000475

§ 371 Date: Feb. 22, 2023

(30) Foreign Application Priority Data
Jan. 15, 2021 (KR) 10-2021-0005833
Jan. 4, 2022 (KR) 10-2022-0000798

(51) Int. Cl. H01M 50/383; H01M 50/325; H01M 50/271; H01M 50/204

(52) U.S. Cl. CPC H01M 50/383; H01M 50/325; H01M 50/271; H01M 50/204

(57) ABSTRACT

A battery module including a battery cell stack in which a plurality of battery cells are stacked; a housing for housing the battery cell stack; and front and rear end plates for covering the front and rear surfaces, respectively, of the battery cell stack. At least one of the housing, front end plate or rear end plate includes a venting part for discharging gas and flame, and the venting part has a shape that bends a discharge path of the gas and flame.

### CROSS-REFERENCE TO RELATED APPLICATIONS

This application is a US national phase of international Application No. PCT/KR2022/000475 filed on Jan. 11, 2022, and claims priority to Korean Patent Application Nos.10-2021-0005833 filed on Jan. 15, 2021 and 10-2022-0000798 filed on Jan. 4, 2022, the entire contents of which are incorporated as if fully set forth herein.

### TECHNICAL FIELD

The present disclosure relates to a battery module and a battery pack including the same, and more particularly, to a battery module with improved safety and a battery pack including the same.

### BACKGROUND

In modern society, as portable devices such as a mobile phone, a notebook computer, a camcorder and a digital camera are being used daily, the development of technologies in the fields related to mobile devices as described above has been activated. In addition, chargeable/dischargeable secondary batteries are used as a power source for an electric vehicle (EV), a hybrid electric vehicle (HEV), a plug-in hybrid electric vehicle (P-HEV) and the like, in an attempt to solve air pollution and the like caused by existing gasoline vehicles using fossil fuel. Therefore, there is a growing need for development of a secondary battery.

Currently commercialized secondary batteries include a nickel cadmium battery, a nickel hydrogen battery, a nickel zinc battery, a lithium secondary battery, and the like. Among them, the lithium secondary battery has come into the spotlight because they have certain advantages, for example, they exhibit minimal memory effects compared to nickel-based secondary batteries and thus can be freely charged and discharged, and have very low self-discharge rate and high energy density.

Such lithium secondary batteries mainly use a lithium-based oxide and a carbonaceous material as a positive electrode active material and a negative electrode active material, respectively. The lithium secondary battery includes an electrode assembly in which a positive electrode plate and a negative electrode plate, each coated with the positive electrode active material and the negative electrode active material, respectively, are disposed with a separator being interposed between them, and a battery case that seals and houses the electrode assembly together with an electrolyte solution.

Generally, the lithium secondary battery may be classified based on the shape of the exterior material into a can type secondary battery, in which the electrode assembly is mounted in a metal can, and a pouch-type secondary battery, in which the electrode assembly is mounted in a pouch made of an aluminum laminate sheet.

In the case of a secondary battery used for small-sized devices, two to three battery cells are disposed, but in the case of a secondary battery used for a medium- or large-sized device such as an automobile, a battery module in which a large number of battery cells are electrically connected is used. In such a battery module, a large number of battery cells are connected to each other in series or in parallel to form a cell stack, thereby improving capacity and output. In addition, one or more battery modules may be mounted together with various control and protection systems such as BDU (battery disconnect unit), BMS (battery management system) and a cooling system to form a battery pack.

FIG. 1 is a perspective view showing a conventional battery module.

As illustrated in FIG. 1, the conventional battery module 10 can be manufactured by housing a battery cell stack (not shown) in the housing 20 and then joining the end plate 40 to the open portion of the housing 20. At this time, a terminal busbar opening 41H, where a part of the terminal busbar is exposed, and a module connector opening 42H, where a part of the module connector is exposed, can be formed in the end plate 40. The terminal busbar opening 41H is for guiding the high voltage (HV) connection of the battery module 10, and the terminal busbar exposed through the terminal busbar opening 41H can be connected to another battery module or a BDU (battery disconnect unit). The module connector opening 42H is for guiding the LV (Low voltage) connection of the battery module 10, and the module connector exposed through the module connector opening 42H is connected to a BMS (battery management system) and can transmit voltage information, temperature information, or the like of the battery cells.

FIG. 2 is an illustration of the battery module of FIG. 1 mounted in the conventional battery pack viewed at the time of ignition. FIG. 3 is a cross-sectional view taken along line I-I′ of FIG. 2, which is a cross-sectional view of the appearance of a flame that affects adjacent battery modules during ignition of a conventional battery module.

As illustrated in FIGS. 1 to 3, the conventional battery module 10 includes a battery cell stack in which a plurality of battery cells 11 are stacked, a housing 20 that houses the battery cell stack, and end plates 40 that are formed on the front and rear surfaces of the battery cell stack.

When a battery cell is affected by physical, thermal or electrical damage, including overcharging, the internal pressure of the battery cell 11 increases and exceeds a limit value of the fusion strength of the battery cell 11. In such a case, the high-temperature heat, gas, and flame generated in the battery cell 11 can be discharged to the outside of the battery cell 11.

In this situation, the high-temperature heat, gas and flame may be discharged through the openings 41H and 42H formed in the end plate 40. However, in the battery pack in which a plurality of battery modules 10 are arranged so that the end plates 40 face each other, the high-temperature heat, gas and flame ejected from the battery module 10 may affect an adjacent battery module 10. Thereby, the terminal busbar or the like formed on the end plate 40 of the adjacent battery module may be damaged, and high-temperature heat, gas and flame may enter the interior of the adjacent battery module 10 via the openings formed in the end plates 40 of the adjacent battery module 10 to damage other electrical components including the plurality of battery cells 11. In addition, this leads to heat propagation to the adjacent battery modules 10, which cause a chain ignition in the battery pack.

Therefore, when heat propagation occurs within the battery module, there is a need to develop a technology capable of controlling a high-temperature flame to minimize the impact on adjacent battery modules.

### SUMMARY

It is an objective of the present disclosure to provide a battery module that can control the flame discharge path when an ignition phenomenon occurs inside the battery module, and a battery pack including the same.

However, the problem to be solved by embodiments of the present disclosure is not limited to the above-described problems, and can be variously expanded within the scope of the technical idea included in the present disclosure.

According to one embodiment of the present disclosure, there is provided a battery module comprising: a battery cell stack in which a plurality of battery cells are stacked; a housing for housing the battery cell stack; and a pair of end plates for covering the front and rear surfaces of the battery cell stack, wherein at least one of the housing or the end plates includes a venting part for discharging gas and flame, and wherein the venting part has a shape that guides the discharge path of the gas and flame so as to be bent.

The venting part may include a through hole formed in at least one of the housing and the end plates; a first cover part for covering the through hole; and a first opening formed on one side of the first cover part and communicating with the through hole.

The end plates may include a first end plate and a second end plate which are located so as to cover the front and rear surfaces of the battery cell stack, respectively, and the first cover part may be connected to the first end plate at a portion where the first opening is not formed.

An area of the first cover part may be larger than an opening area of the through hole.

An opening direction of the through hole may be different from an opening direction of the first opening.

An opening direction of the through hole and an opening direction of the first opening may be perpendicular to each other.

The venting part may further include a second cover part for covering the through hole while being located on the opposite side of the first cover part with respect to the through hole; and a second opening formed on one side of the second cover part and communicating with the through hole.

An area of the second cover part may be larger than an opening area of the through hole.

An opening direction of the through hole may be different from an opening direction of the second opening.

An opening direction of the through hole and an opening direction of the second opening may be perpendicular to each other.

The discharge path of the gas and flame may be bent at least twice by the first cover part and the second cover part.

The venting part may guide discharge of the gas and flame in a direction parallel to one surface of at least one of the housing and the end plates.

The battery module may further include a pair of insulating covers, each of which is located between the battery cell stack and the respective end plate, wherein the venting part is formed in the end plate, and an insulating cover opening may be formed at a position corresponding to the venting part of the insulating cover.

According to embodiments of the present disclosure, the discharge path of the flame generated within the battery module can be prevented from being in a straight line, thereby effectively regulating flame discharge without affecting the gas discharge function.

In addition, considering the nature of the flame with a strong straight-line tendency, the flame discharge path can be prevented from being in a straight line, thereby preventing direct damages on adjacent battery modules.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view of a conventional battery module;

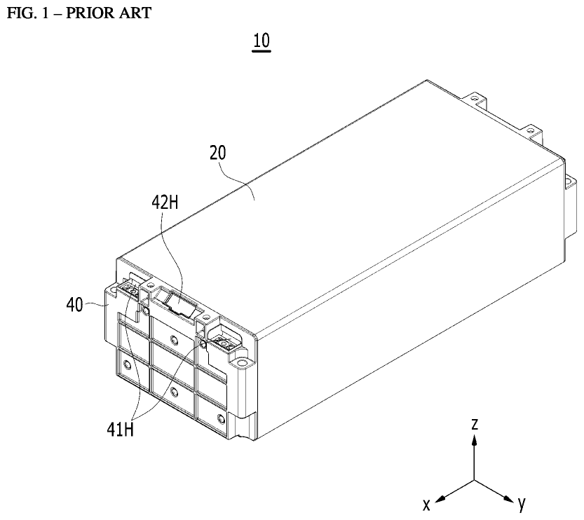

FIG. 2 is an illustration of the battery module of FIG. 1 mounted in the conventional battery pack at the time of ignition;

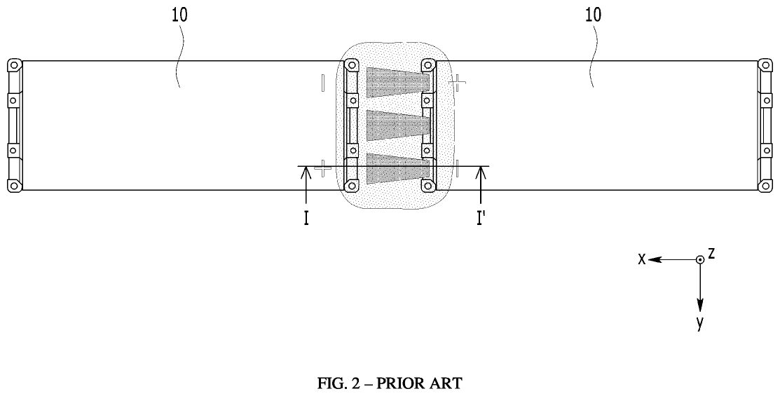

FIG. 3 is a cross-sectional view along line I-I′ of FIG. 2;

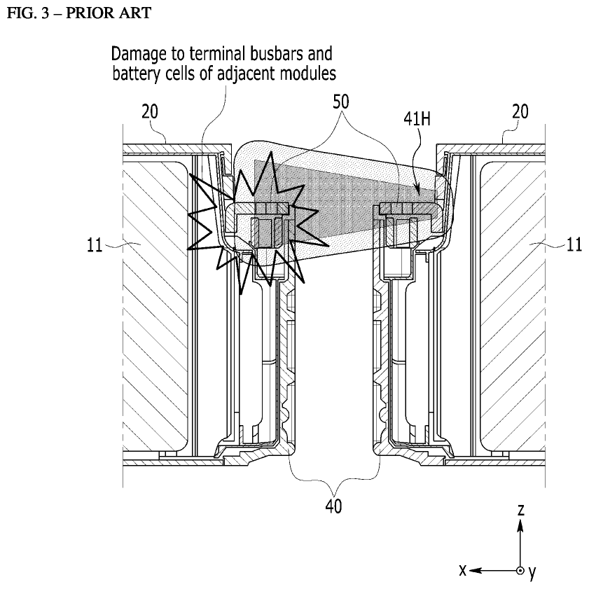

FIG. 4 is a perspective view of a battery module according to an embodiment of the present disclosure;

FIG. 5 is an exploded perspective view of the battery module of FIG. 4;

FIG. 6 is a perspective view of a battery cell included in the battery module of FIG. 5;

FIG. 7 is a perspective front view of the second end plate of the battery module of FIG. 4;

FIG. 8 is a perspective view of an end plate and an insulating cover according to an embodiment of the present disclosure;

FIG. 9 is a cross-sectional perspective view along line A-A′ of FIG. 8;

FIG. 10 is a cross-sectional view of the cut end plate and the insulating cover of FIG. 9 as viewed in the −y-axis direction on the xz plane;

FIG. 11 is a perspective view of the end plate and the insulating cover of FIG. 8 when viewed in a direction facing the battery cell stack;

FIG. 12 is a perspective view of a battery module according to another embodiment of the present disclosure;

FIG. 13 is a cross-sectional view along line B-B′ of FIG. 12;

FIG. 14 is a perspective view of an end plate and an insulating cover according to a modified embodiment of the present disclosure;

FIG. 15 is a cross-sectional perspective view along line C-C′ of FIG. 14;

FIG. 16 is a cross-sectional view of the cut end plate and the insulating cover of FIG. 15 as viewed in the −y-axis direction on the xz plane; and

FIG. 17 is a perspective view of the end plate and the insulating cover of FIG. 14 when viewed in a direction facing the battery cell stack.

### DETAILED DESCRIPTION

Hereinafter, various embodiments of the present disclosure will be described in detail with reference to the accompanying drawings so that those skilled in the art can easily carry out the embodiments. The present disclosure may be modified in various different ways, and is not limited to the embodiments set forth herein.

A description of parts not related to the description will be omitted herein for clarity, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed on the upper end of the reference portion toward the opposite direction of gravity.

Further, throughout the description, when a portion is referred to as “including” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

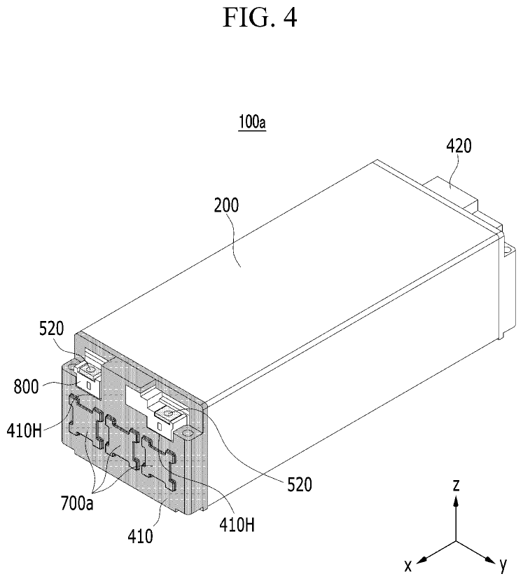

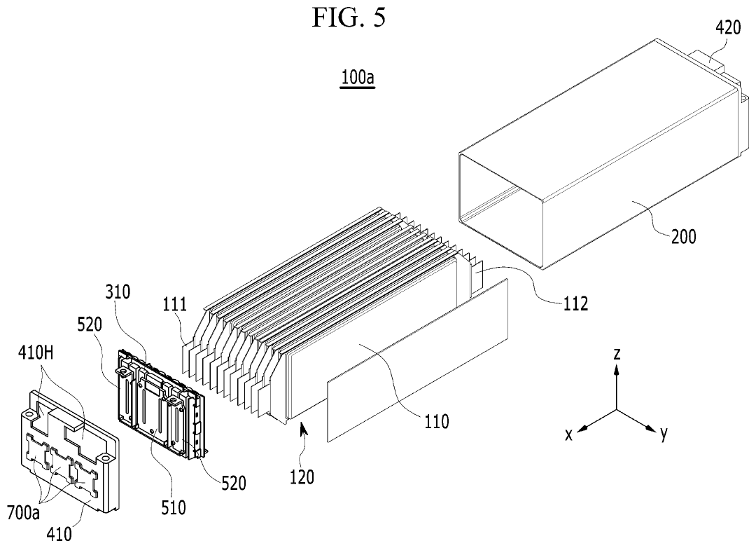

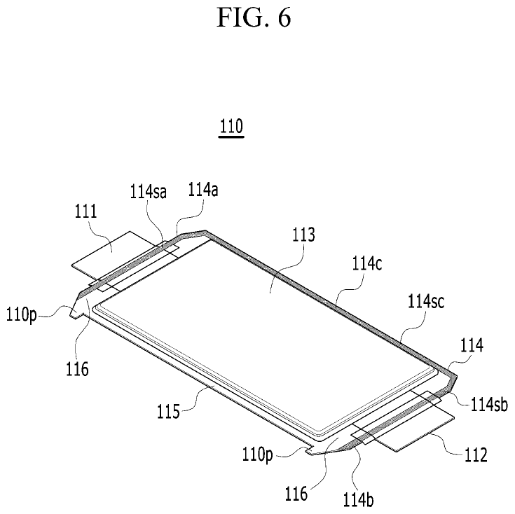

FIG. 4 is a perspective view of a battery module according to an embodiment of the present disclosure. FIG. 5 is an exploded perspective view of the battery module of FIG. 4. FIG. 6 is a perspective view of a battery cell included in the battery module of FIG. 5.

As illustrated in FIGS. 4 to 6, a battery module 100a according to an embodiment of the present disclosure includes a battery cell stack 120 in which a plurality of battery cells 110 are stacked; a housing 200 for housing the battery cell stack 120; and a pair of end plates 410 and 420 for covering the front surface and rear surface of the battery cell stack 120, respectively.

As illustrated in FIG. 6, the battery cell 110 is preferably a pouch-type battery cell. For example, the battery cell 110 according to the present embodiment has a structure in which two electrode leads 111 and 112 face each other and protrude from one end 114a and the other end 114b of the cell main body 113, respectively. More specifically, the electrode leads 111 and 112 are connected to an electrode assembly (not shown), and protrude from the electrode assembly (not shown) to the outside of the battery cell 110.

The battery cell 110 can be manufactured by joining both end parts 114a and 114b of the cell case 114 and one side part 114c connecting them, in a state in which the electrode assembly (not shown) is housed in a cell case 114. In other words, the battery cell 110 according to the present embodiment has a total of three sealing parts 114sa, 114sb and 114sc, the sealing parts 114sa, 114sb and 114sc have a structure sealed by a method such as heat fusion, and the remaining other side part may be formed of a connection part 115. The cell case 114 may be formed of a laminated sheet containing a resin layer and a metal layer.

In addition, the connection part 115 may extend along one edge of the battery cell 110, and a protrusion part 110p of the battery cell 110 called a bat-ear may be formed at an end part of the connection part 115. Further, while the cell case 114 is sealed with the protruding electrode leads 111 and 112 being interposed therebetween, a terrace part 116 may be formed between the respective electrode leads 111 and 112 and the cell main body 113. That is, the battery cell 110 includes a terrace part 116 formed to extend from the cell case 114 in a protruding direction of the electrode leads 111 and 112, respectively.

A plurality of battery cells 110 may be included, and the plurality of battery cells 110 may be stacked to be electrically connected to each other, thereby forming a battery cell stack 120. As illustrated in FIG. 5, the battery cells 110 can be stacked along the y-axis direction to form a battery cell stack 120. A first busbar frame 310 may be located on one surface of the battery cell stack 120 in the protruding direction (x-axis direction) of the electrode leads 111. Although not specifically shown, a second busbar frame may be located on the other surface of the battery cell stack 120 in the protruding direction (−x-axis direction) of the electrode leads 112. The battery cell stack 120 and the first busbar frame 310 may be housed together in the housing 200. The housing 200 can protect the battery cell stack 120 housed inside the housing 200 and the electrical components connected thereto from external physical impacts.

The housing 200 can be open in the protruding direction of the electrode leads 111 and 112 (x-axis direction, −x-axis direction), and each of a pair of end plates 410 and 420 may be located on the respective open ends of the housing 200. The two end plates 410 and 420 are referred to as a first end plate 410 and a second end plate 420, respectively. The first end plate 410 can be joined to the housing 200 while covering the first busbar frame 310, and the second end plate 420 can be joined to the housing 200 while covering the second busbar frame (not shown). That is, a first busbar frame 310 may be located between the first end plate 410 and the battery cell stack 120, and a second busbar frame (not shown) may be located between the second end plate 420 and the battery cell stack 120. Further, an insulating cover 800 (see FIG. 4) for electrical insulation may be located between the first end plate 410 and the first busbar frame 310.

The first end plate 410 and the second end plate 420 are located to cover the one surface and the other surface of the battery cell stack 120, respectively. The first end plate 410 and the second end plate 420 can protect the first busbar frame 310 and various electrical components connected thereto from external impact. For this purpose, the first end plate 410 and the second end plate 420 must have a predetermined strength and may include a metal such as aluminum. Further, the first end plate 410 and the second end plate 420 may be joined to a corresponding edge of the housing 200 by a method such as welding.

The first busbar frame 310 is located on one surface of the battery cell stack 120 to cover the battery cell stack 120 and at the same time, guide the connection between the battery cell stack 120 and an external device. Specifically, at least one of the busbars, the terminal busbar and the module connector may be mounted on the first busbar frame 310. In particular, at least one of the busbars, the terminal busbar and the module connector may be mounted on a surface opposite to the surface where the first busbar frame 310 faces the battery cell stack 120. In one example, as illustrated in FIG. 5, a busbar 510 and a terminal busbar 520 are mounted on the first busbar frame 310.

The electrode lead 111 of the battery cells 110 is bent after passing through the slit formed in the first busbar frame 310 and can be joined to the busbar 510 or the terminal busbar 520. The battery cells 110 constituting the battery cell stack 120 may be connected in series or in parallel by the busbar 510 or the terminal busbar 520. Further, the battery cells 110 can be electrically connected to an external device or circuit through the terminal busbar 520 exposed to the outside of the battery module 100a.

The first busbar frame 310 may include an electrically insulating material. The first busbar frame 310 restricts the busbar 510 or the terminal busbar 520 from making contact with the battery cells 110, except for the portion where the busbar 510 or the terminal busbar 520 is joined to the electrode leads 111, thereby preventing the occurrence of a short circuit.

As described above, the second busbar frame may be located on the other surface of the battery cell stack 120, and at least one of the busbar, terminal busbar, and module connector may be mounted on the second busbar frame. An electrode lead 112 can be joined to such a bus bar.

An opening in which at least one of the terminal busbar and the module connector is exposed can be formed in the first end plate 410 according to the present embodiment. The opening may be a terminal busbar opening or a module connector opening. In one example, as illustrated in FIGS. 4 and 5, a terminal busbar opening 410H where the terminal busbar 520 is exposed can be formed in the first end plate 410. The terminal busbar 520 further includes an upwardly protruding portion as compared with the busbar 510. Such an upwardly protruding portion is exposed to the outside of the battery module 100a via the terminal busbar opening 410H. The terminal busbar 520 exposed via the terminal busbar opening 410H may be connected to another battery module or a battery disconnect unit (BDU) to form a high voltage (HV) connection.

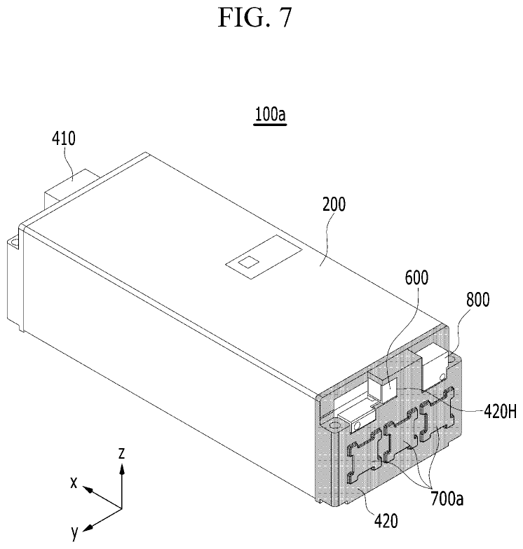

FIG. 7 is a front perspective view of the second end plate of the battery module of FIG. 4.

As illustrated in FIG. 7, as an example, a module connector opening 420H where the module connector 600 is exposed can be formed in the second end plate 420. This means that the module connector 600 is mounted on the above-mentioned second busbar frame. The module connector 600 can be connected to a temperature sensor, a voltage measuring member, or the like provided inside the battery module 100a. Such a module connector 600 is connected to an external BMS (battery management system) to form an LV (Low voltage) connection, and it transmits temperature information, voltage level and the like measured by the temperature sensor or the voltage measuring member to the external BMS.

The first end plate 410 and the second end plate 420 shown in FIGS. 4, 5 and 7 are exemplary structures. According to another embodiment of the present disclosure, the module connector is mounted on the first busbar frame 310, and a terminal busbar can be mounted on the second busbar frame. Therefore, a module connector opening can be formed in the first end plate, and a terminal busbar opening can be formed in the second end plate.

The end plates 410 and 420 according to the present embodiment cover the front surface and rear surface of the battery cell stack 120, respectively, and the housing 200 covers the upper surface, lower surface and both side surfaces of the battery cell stack 120. Here, the front surface means a surface of the battery cell stack 200 in the +y-axis direction, and the rear surface means a surface of the battery cell stack 200 in the −y-axis direction. The upper surface means a surface of the battery cell stack 200 in the +z-axis direction, the lower surface means a surface of the battery cell stack 200 in the −z-axis direction, and the both side surfaces mean the surfaces of the battery cell stack 200 in the +x-axis and −x-axis directions, respectively. However, these are the surfaces indicated for convenience of explanation, and may vary depending on a position of an object, a position of an observer, or the like. As described above, the front surface and the rear surface of the battery cell stack 200 may be surfaces on which the protruding first and second electrode leads 111 and 112 of the battery cells 110 are located.

According to the present embodiment, at least one of the housing 200 or the end plates 410 and 420 may include a venting part 700a for discharging gas and flame.

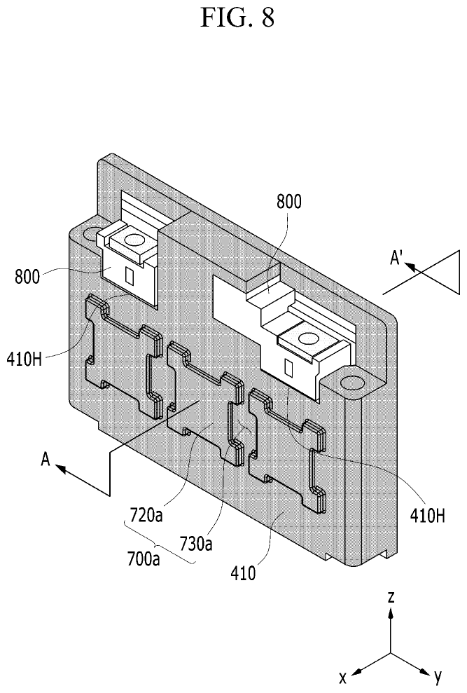

Hereinafter, according to an embodiment of the present disclosure, a venting part formed on the first end plate will be described in detail with reference to FIGS. 8 to 11. The first end plate 410 is mainly described to avoid repetition of the description, but the same or similar structure can be applied to the second end plate 420.

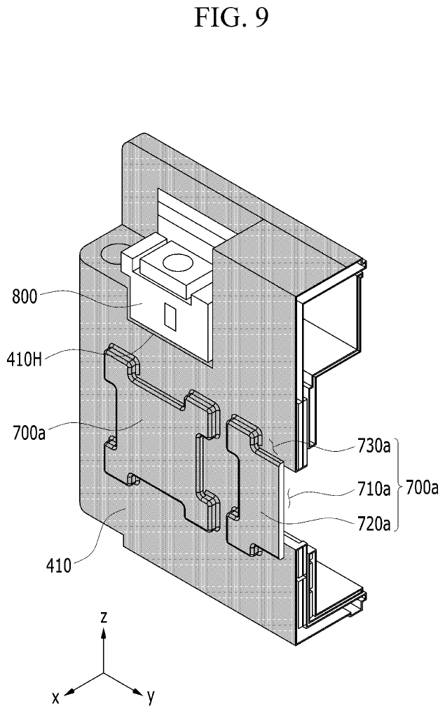

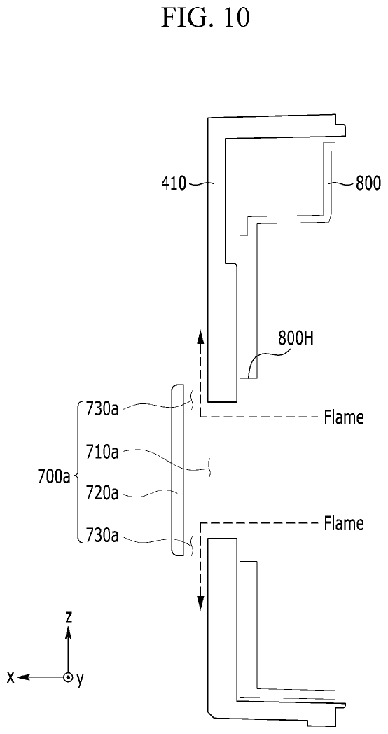

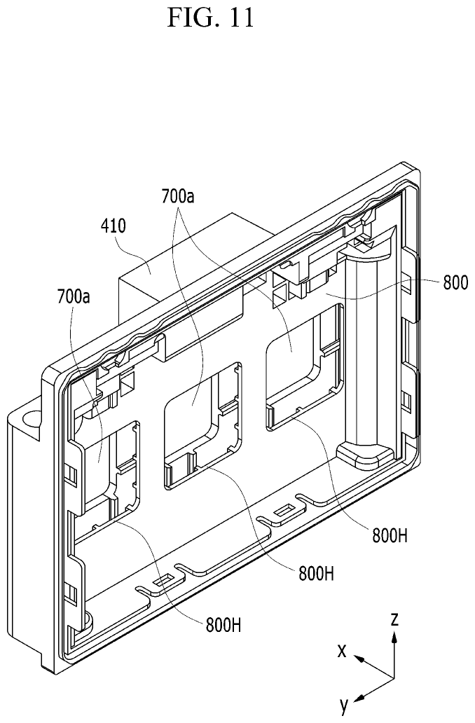

FIG. 8 is a perspective view of an end plate and an insulating cover according to an embodiment of the present disclosure. FIG. 9 is a cross-sectional perspective view along line A-N of FIG. 8. FIG. 10 is a cross-sectional view of the cut end plate and the insulating cover of FIG. 9 as viewed in the −y-axis direction on the xz plane. FIG. 11 is a perspective view of the end plate and the insulating cover of FIG. 8 when viewed in a direction facing the battery cell stack.

As illustrated in FIGS. 8 to 11, the venting part 700a according to the present embodiment has a shape that guides the discharge path of the gas and flame to be bent. That is, the venting part 700a includes a path that connects the interior of the battery module 100a wrapped by the housing 200 and the end plates 410 and 420 to the outside, and the gas and flame are discharged through the path, but the path is not formed in a straight line, and includes a bent part that guides the discharge path of the gas and flame to be bent.

Specifically, the venting part 700a may include a through hole 710a formed in the first end plate 410; a first cover part 720a for covering the through hole 710a; and a first opening 730a formed on one side of the first cover part 720a and communicating with the through hole 710a. Here, the first cover part 720a does not cover one side of the through hole 710a as if completely sealed, but is positioned apart from each other by a predetermined interval. The first opening 730a may be formed by a space in which the first cover part 720a is spaced apart from one surface of the first end plate 410.

The through hole 710a and the first opening 730a may be paths through which the gas and flame described above are discharged.

The first cover part 720a may have a shape that covers the through hole 710a from the outside. Further, the first cover part 720a may be connected to the first end plate 410 at a portion where the first opening 730a is not formed. In order to form such a structure, the area of the first cover part 720a may be larger than the opening area of the through hole 710a.

Although it is illustrated that four first openings 730a are formed in the +y-axis direction, the −y-axis direction, the +z-axis direction, and the −z-axis direction with respect to one venting part 700a, the number of the first openings 730a is not particularly limited. Further, the opening direction of the first opening 730a is not limited as long as it does not coincide with the opening direction of the through opening 710a.

In the case of the conventional battery module 10, as described above, high-temperature heat, gas, and flame are intensively discharged through the terminal busbar opening 41H or the module connector opening 42H, which may damage adjacent battery modules 10.

On the other hand, in the case of battery module 100a of the present embodiment, a separate venting part 700a is provided, whereby the discharge of gas or flame is dispersed, and the gas and flame discharged from the terminal busbar opening 410H and the module connector opening 420H can be significantly reduced.

Further, gas or flame does not pass through the through hole 710a in a straight line because the first cover portion 720a covers the through hole 710a. That is, as shown in FIG. 10, the venting part 700a including the first cover part 720a and the first opening part 730a can guide the discharge path of the gas and flame to be bent.

Specifically, the opening direction of the through opening 710a and the opening direction of the first opening 730a may be different from each other. More specifically, the opening direction of the through hole 710a and the opening direction of the first opening 730a may be perpendicular to each other. In one example, as shown in FIG. 10, the opening direction of the through hole 710a is a direction parallel to the x-axis, whereas the opening direction of the first opening 730a may be a direction parallel to the yz plane or a direction close to the yz plane.

Thereby, the venting part 700a can guide the discharge of gas and flame in a direction parallel to one surface of the first end plate 410.

In the case of the high-temperature gas, even if the discharge path is formed to be bent, there is no particular limitation on the discharge to the outside. On the other hand, in the case of a flame or spark with a strong straight-line tendency, if the discharge path is designed to be bent as in the present embodiment, it is possible to restrict the direct injection toward the adjacent battery modules or the like. The venting part 700a according to the present embodiment can suppress the flame from being directly discharged, and even if the flame is discharged, the direction is regulated, and damage to other adjacent battery modules can be minimized That is, there is an advantage that the damage caused by the flame can be reduced without deteriorating the gas discharge function.

The number of such venting parts 700a is not particularly limited, and can be arranged as a single venting part 700a or a plurality of venting parts 700a. In one example, three venting parts 700a can be provided, as illustrated in FIGS. 8 to 11.

As described above, an insulating cover 800 for electrical insulation can be located between the first end plate 410 and the first busbar frame 310 (see FIG. 5). Any material that is electrically insulating can be applied as an insulating cover 800 without limitation. As illustrated in FIG. 11, an insulating cover opening 800H may be formed at a position corresponding to the venting part 700a of the insulating cover 800. A high-temperature gas or flame inside the battery module may sequentially pass through the insulating cover opening 800H and the venting part 700a and be discharged to the outside.

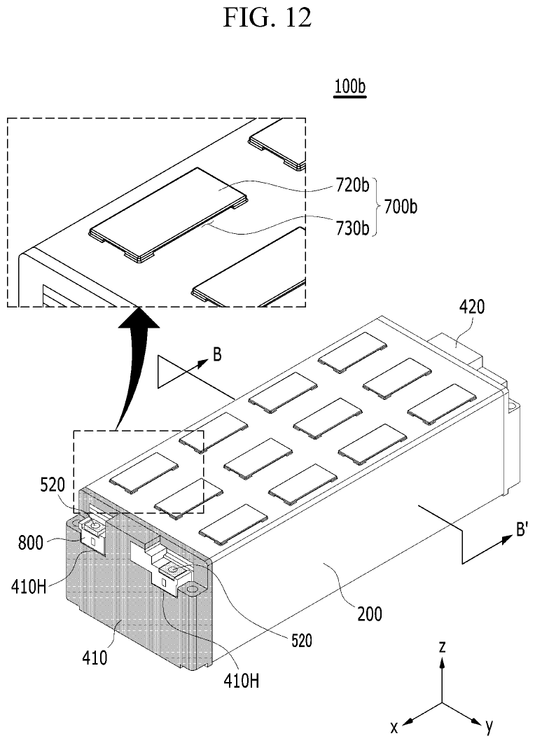

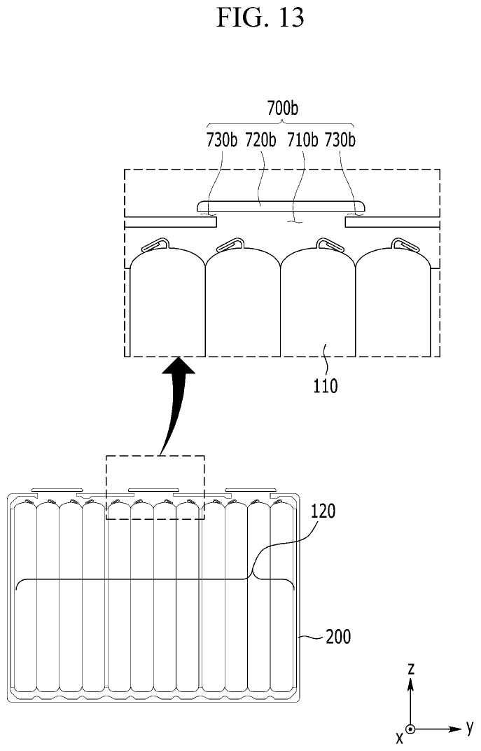

Next, a venting part formed in the housing according to another embodiment of the present disclosure will be described in detail with reference to FIGS. 12 and 13.

FIG. 12 is a perspective view of a battery module according to another embodiment of the present disclosure. FIG. 13 is a cross-sectional view along line B-B′ of FIG. 12.

As illustrated in FIGS. 12 and 13, the battery module 100b according to another embodiment of the present disclosure includes a housing 200 for housing the battery cell stack 120 and a venting part 700b formed in the housing 200. The venting part 700b has a shape that guides the discharge path of the gas and flame to be bent. That is, the venting part 700b includes a path that connects the interior of the battery module 100b wrapped by the housing 200 and the end plates 410 and 420 to the outside, and the gas and the flame are discharged through the path, but the path is not composed only of a straight line, but includes a bent portion, so that the discharge path of the gas and the flame is guided to be bent.

The venting part 700b includes a through hole 710b formed in the housing 200; a first cover part 720b for covering the through hole 710b; and a first opening 730b formed on one side of the first cover part 720b and communicating with the through hole 710b. Similar to a previous embodiment, the first cover part 720b does not cover one side of the through hole 710b as if completely sealed, but may be positioned apart from each other by a predetermined interval. The first opening 730a can be formed by a space where the first cover part 720b is spaced apart from one surface of the housing 200.

The through hole 710b and the first opening 730b may be the paths through which the gas and flame are discharged as described above.

The first cover part 720b may have a shape that covers the through hole 710b from the outside. Further, the first cover part 720b may be connected to the housing 200 at a portion where the first opening 730b is not formed. In order to form such a structure, the area of the first cover part 720b may be larger than the opening area of the through hole 710b.

Similar to the venting part 700a formed in the end plates 410 and 420, the venting part 700b according to the present embodiment includes a first cover part 720b and a first opening 730b, and thus can guide the discharge path of the flame to be bent.

Specifically, the opening direction of the through hole 710b may be different from the opening direction of the first opening 730b. More specifically, the opening direction of the through hole 710b and the opening direction of the first opening 730b may be perpendicular to each other. In one example, as shown in FIG. 13, the opening direction of the through hole 710b is a direction parallel to the z-axis, whereas the opening direction of the first opening 730b is a direction parallel to the xy plane or a direction close to the xy plane. Thereby, the venting part 700b can guide the discharge of the gas and flame in a direction parallel to one surface of the housing 200. The venting part 700b according to the present embodiment has the advantage that damage due to flame can be reduced without deteriorating the gas discharge function. The details are omitted because they overlap with the contents explained above.

On the other hand, since the housing 200 may have a relatively large area as compared with the end plates 410 and 420, the number of venting parts 700b may be increased as compared with the case where the end plates 410 and 420 are formed. Further, the opening area of the first opening 730b can be increased. The increased number of venting parts 700b or the opening area of the first opening 730b is more effective in dispersing gas or flame.

Further, since the venting part 700b is formed on one surface of the housing 200, it is possible to reduce gas or flame itself discharged in the direction in which the end plate is located.

In particular, as shown in the figure, the venting parts 700b may be formed on the upper surface of the housing 200. In this case, the discharge of gas or flame may be guided to occur at the upper part of the battery module 100b. Therefore, it is possible to reduce damage affecting other battery modules mainly disposed on the side surfaces.

On the other hand, the venting part 700a formed in the end plates 410 and 420 and the venting part 700b formed in the housing 200 are distinguishably described, but the battery module according to another embodiment of the present disclosure may include both the venting part 700a formed in the end plates 410 and 420 and the venting part 700b formed in the housing 200.

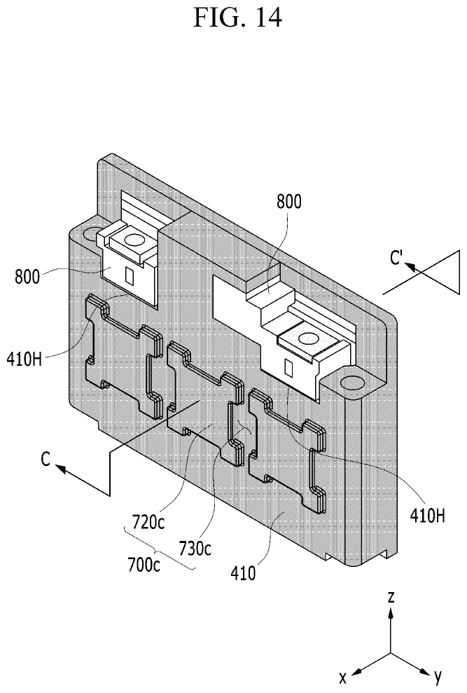

Next, a venting unit according to a modified embodiment of the present disclosure will be described in detail with reference to FIGS. 14 to 17. The first end plate 410 is mainly described in order to avoid repetition of the description, but the same or similar structure can be applied to the housing 200 or the second end plate 420.

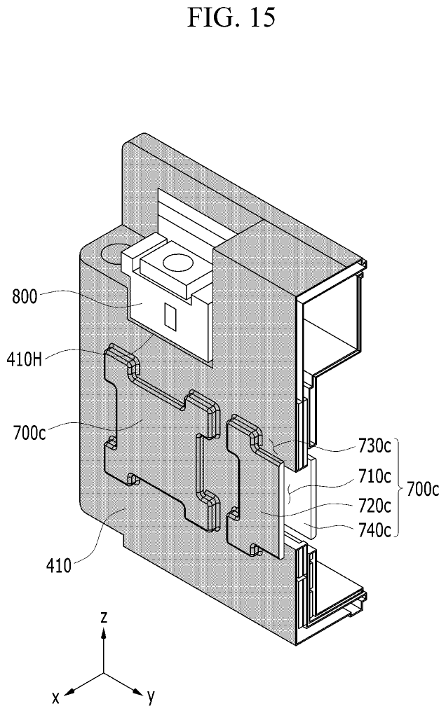

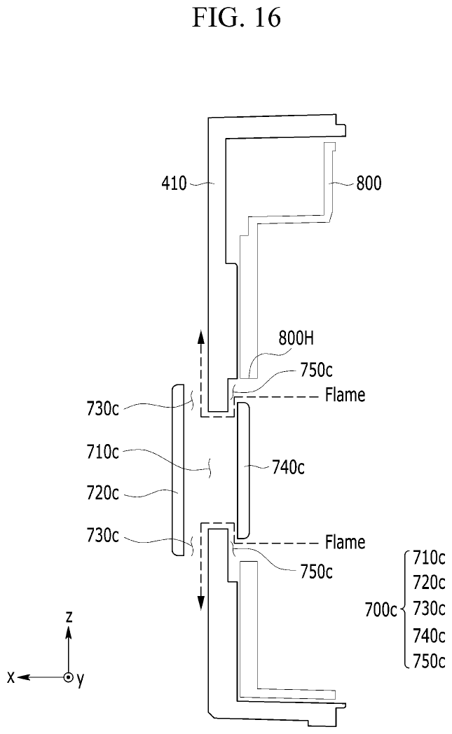

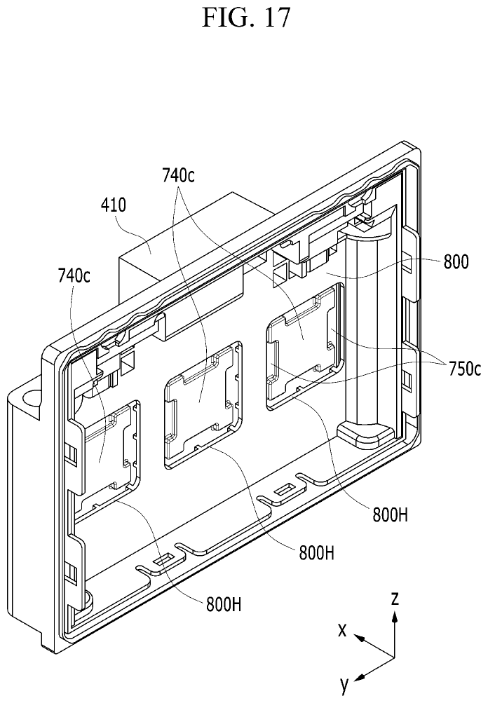

FIG. 14 is a perspective view of an end plate and an insulating cover according to a modified embodiment of the present disclosure. FIG. 15 is a cross-sectional perspective view along line C-C′ of FIG. 14. FIG. 16 is a cross-sectional view of the cut end plate and the insulating cover of FIG. 15 as viewed in the -y-axis direction on the xz plane. FIG. 17 is a perspective view of the end plate and the insulating cover of FIG. 14 when viewed from a direction facing the battery cell stack.

As illustrated in FIGS. 14 to 17, the venting part 700c according to a modified embodiment of the present disclosure includes a through hole 710c formed in the first end plate 410; a first cover part 720c for covering the through hole 710c; and a first opening 730c formed on one side of the first cover part 720c and communicating with the through hole 710c. Additionally, the venting part 700c may further includes a second cover part 740c for covering the through hole 710c while being located on the opposite side of the first cover part 720c with respect to the through hole 710c; and a second opening 750c formed on one side of the second cover part 740c and communicating with the through hole 710c. That is, the venting part 700c according to the present embodiment may have a configuration in which a second cover part 740c and a second opening 750c are further added to the venting part 700a described above. The first cover part 720c and the second cover part 740c may be positioned apart from each other by a predetermined interval, instead of covering one side and the other side of the through hole 710a as if completely sealed, respectively. A first opening 730a can be formed by a space where the first cover portion 720c is spaced apart from one surface of the first end plate 410, and the second opening 750c can be formed by a space in which the second cover part 740c is spaced apart from the other surface of the first end plate 410.

The first opening 730c, the through hole 710c, and the second opening 750c may be paths through which the gas and flame are discharged.

The second cover part 740c and the first cover part 720c may be positioned to face each other with the through hole 710c interposed therebetween. More specifically, unlike the first cover part 720c that covers the through hole 710c from the outside, the second cover part 740c may have a shape that covers the through hole 710c from the inside. Further, the second cover part 740c may be connected to the first end plate 410 at a portion where the second opening 750c is not formed. In order to form such a structure, the area of the second cover part 740c may be larger than the opening area of the through hole 710c.

Although it is illustrated that four second openings 750c are formed in the +y-axis direction, the −y axis direction, the +z axis direction, and the −z axis direction with respect to one venting part 700c, there is no particular limitation on the number of second openings 750c. Further, the opening direction of the second openings 750c is not particularly limited as long as it does not coincide with the opening direction of the through opening 710c.

Due to the first cover part 720c and the second cover part 740c covering the through hole 710c, gas or flame does not pass through the through hole 710c in a straight line. That is, the discharge path of the gas and flame may be bent at least twice by the first cover part 720c and the second cover part 740c.

Specifically, the opening direction of the through hole 710c and the opening direction of the second opening 750c may be different from each other. More specifically, the opening direction of the through hole 710c and the opening direction of the second opening 750c may be perpendicular to each other. In one example, as shown in FIG. 16, the opening direction of the through hole 710c is a direction parallel to the x-axis, whereas the opening direction of the second opening 750c may be a direction parallel to the yz plane or a direction close to the yz plane. That is, by arranging the second cover part 740c in addition to the first cover part 720c, a path through which the flame is discharged via the venting part 700c can be set to be more complicated. As the flame discharge path becomes more complicated, it is possible to effectively block a flame or spark with a strong straight-line tendency. As the instantaneously bursting flame passes through the second cover part 740c and the first cover part 720c in sequence, the flame intensity may be lowered. In other words, the venting part 700c according to the present embodiment can have a further enhanced flame-extinguishing function.

Even though the terms indicating directions such as upper, lower, left, right, front and rear directions are used herein, it is obvious to those skilled in the art that these merely represent relative positions for convenience in explanation and may vary depending on a position of an observer, a position of an object, or the like.

The one or more battery modules according to the present embodiment as described above can be mounted together with various control and protection systems such as a battery management system (BMS) and a cooling system to form a battery pack.

The battery module or the battery pack can be applied to various devices. Specifically, these devices can be applied to vehicle means such as an electric bicycle, an electric vehicle, a hybrid vehicle, but the present disclosure is not limited thereto and can be applied to various devices that can use the secondary battery.

Although the preferred embodiments of the present disclosure have been described in detail above, the scope of the present disclosure is not limited thereto, and various modifications and improvements made by those skilled in the art using the basic concepts of the present disclosure defined in the following claims also falls within the spirit and scope of the present disclosure.

1. A battery module comprising:
a battery cell stack comprising a plurality of battery cells;
a housing for the battery cell stack; and
front and rear end plates for covering front and rear surfaces, respectively, of the battery cell stack,
wherein at least one of the housing, the front end plate or the rear end plate comprises a venting part for discharging gas and flame, and
wherein the venting part has a shape that bends a discharge path of the gas and flame.

2. The battery module according to claim 1,
wherein the venting part comprises a through hole formed in at least one of the housing, the front end plate or the rear end plate; a first cover part for covering the through hole; and a first opening formed on a side of the first cover part and communicating with the through hole.

3. The battery module according to claim 2,
wherein an area of the first cover part is larger than an opening area of the through hole.

4. The battery module according to claim 2,
wherein an opening direction of the through hole is different from an opening direction of the first opening.

5. The battery module according to claim 2,
wherein an opening direction of the through hole and an opening direction of the first opening are perpendicular to each other.

6. The battery module according to claim 2,
wherein the venting part further comprises a second cover part for covering the through hole, wherein the second cover part is located opposite to the first cover part with respect to the through hole; and a second opening formed on a side of the second cover part and communicating with the through hole.

7. The battery module according to claim 6,
wherein an area of the second cover part is larger than an opening area of the through hole.

8. The battery module according to claim 6,
wherein an opening direction of the through hole is different from an opening direction of the second opening.

9. The battery module according to claim 7,
wherein an opening direction of the through hole and an opening direction of the second opening are perpendicular to each other.

10. The battery module according to claim 6,
wherein the discharge path of the gas and flame is bent at least twice by the first cover part and the second cover part.

11. The battery module according to claim 1,
wherein the venting part guides discharge of the gas and flame in a direction parallel to a surface of at least one of the housing, front end plate or rear end plate.

12. The battery module according to claim 1, further comprising an insulating cover located between the battery cell stack and at least one of the front end plate or rear end plate,
wherein the venting part is formed in the at least one of the front end plate or rear end plate, and
an insulating cover opening is formed at a position corresponding to the venting part of the insulating cover.

13. A battery pack comprising the battery module according to claim 1.

14. The battery module according to claim 2,
wherein the end plates include a first end plate and a second end plate which are located to cover the front and rear surfaces of the battery cell stack, respectively, and
the first cover part is connected to the first end plate at a portion where the first opening is not formed.
